(19) United States
(12) Patent Application Publication
(10) Pub. No.: US 2025/0040630 A1
(43) Pub. Date: Feb. 6, 2025

(54) LUMINOUS GARMENT

(71) Applicants: Chien-Pang LEE, Taoyuan City (TW); LYB LLC., KIRKLAND, WA (US)

(72) Inventors: Chien-Pang LEE, Taoyuan City (TW); Luly Pei YANG, Seattle, WA (US)

(21) Appl. No.: 18/436,280

(22) Filed: Feb. 8, 2024

Related U.S. Application Data
(63) Continuation-in-part of application No. 18/364,803, filed on Aug. 3, 2023, now abandoned.

(51) Int. Cl. A41D 13/01; A41D 27/08; G09F 13/22; G09F 21/02

(52) U.S. Cl. CPC A41D 13/01; A41D 27/085; G09F 13/22; G09F 21/023; G09F 2013/222

(57) ABSTRACT

A luminous garment includes a garment body, a logo element, a power source, a control module, and an operation interface. The garment body is wearable by a user. The logo element is arranged on the surface of the garment body to emit light upon receiving an electrical current flowing therethrough. The operation interface is arranged for operation by the user to generate an operation signal and transmit the operation signal to the control module. The control module is arranged to control, according to the operation signal, a light emission mode of the logo element.

### CROSS-REFERENCE TO RELATED APPLICATIONS

This application is a continuation-in-part of U.S. patent application Ser. No. 18/364,803, filed on Aug. 3, 2023 and entitled LUMINOUS GARMENT, the complete subject matter of which is incorporated herein as reference.

### FIELD OF THE INVENTION

The present invention relates to clothing, and more particularly to clothing that includes a light emission element to allow a user to actively control the emission of light.

### BACKGROUND OF THE INVENTION

Nighttime workers often are troubled by the insufficient lighting in the work site, and safety concerns come up. Thus, it is necessary to add light reflectors or lighting devices to the clothing that they wear to catch the attention of other people. For example, technicians often need to work in the nighttime to avoid traffic rush hours. For technicians to work safely during the nighttime, the workwear must have an eye-catching effect to warn the passing vehicles and pedestrians.

Workwear is often added with reflective strips to achieve an effect of light reflecting. However, in a place where lighting is poor, the reflective strips may not be sufficiently eye-catching. Some long afterglow luminescent materials can absorb artificial light or sunlight to store light therein and to give off light in the nighttime or in a dark place. However, if these materials are not properly illuminated during the daytime, they will not work properly in the nighttime and after a period of time, the light they give off will slowly dim and disappear. As such, applying long afterglow luminescent materials to the workwear is still not practical.

### SUMMARY OF THE INVENTION

In view of the above problems, the present inventor develops and creates a luminous garment that overcomes the above drawbacks of the prior art and enhances industrial utilization.

The technical solution adopted in the present invention provides a luminous garment, which comprises: a garment body for being put on a wearer; a logo element arranged on a surface of the garment body to receive an electrical current to flow therethrough to emit light, the logo element comprising a luminescence sheet and a pattern layer, the luminescence sheet comprising a protective layer, a back electrode layer, an insulating layer, a luminescent layer, and a transparent conductive layer, the transparent conductive layer and the insulating layer being respectively arranged on the upper and lower sides of the luminescent layer, the back electrode layer being arranged between the insulating layer and the protective layer, the other side of the protective layer being fixed to the surface of the garment body, the pattern layer being arranged on the other side of the transparent conductive layer; a power source, which is arranged on the garment body and is connected by an electrically conductive line to the logo element; a control module arranged on the garment body, the control module being electrically connected to the power source and the logo element; and an operation interface arranged on the garment body and being electrically connected with the control module, the operation interface being arranged for operation by the wearer to generate an operation signal and to transmit the operation signal to the control module; wherein the control module is arranged to control a light emission mode of the logo element according to the operation signal; wherein the two ends of the electrically conductive line are respectively fixed on the transparent conductive layer and the back electrode layer.

In an embodiment of the luminous garment of the present invention, the operation interface comprises a pushbutton switch.

In an embodiment of the luminous garment of the present invention, the control module is connected to the power source by means of a connection line that is curled in a helical form, and the power source is detachably connected with the connection line.

In an embodiment of the luminous garment of the present invention, the garment body includes an inside pocket and an outside pocket, and the control module is arranged in the inside pocket, and the power source is arranged in the outside pocket, and the connection line extends through a hole that is in communication with the inside pocket and the outside pocket to connect to the control module and the power source.

In an embodiment of the luminous garment of the present invention, the control module is detachably connected with the electrically conductive line and the connection line.

In an embodiment of the luminous garment of the present invention, the logo element comprises marking that may comprise digitals, characters, or patterns, or a combination of two of digital, character, and pattern.

In an embodiment of the luminous garment of the present invention, the electrically conductive line comprises an electrical wire or a printed circuit.

In an embodiment of the luminous garment of the present invention, a part of the electrically conductive line extends along an edge of the garment body to connect to the logo element.

In an embodiment of the luminous garment of the present invention, the luminous garment further comprises a LED light strip, and the LED light strip is arranged on the garment body.

In an embodiment of the luminous garment of the present invention, the luminous garment further comprises a communication module, and the communication module is arranged on the garment body, and the communication module is arranged for operation by a user to transmit a distress signal to a remote device.

In an embodiment of the luminous garment of the present invention, the luminous garment further comprises a dog repellent device, and the dog repellent device is arranged on the garment body.

In an embodiment of the luminous garment of the present invention, the luminous garment further comprises a heating plate, and the heating plate is arranged on the garment body.

In an embodiment of the luminous garment of the present invention, the luminescence sheet is an electro luminescence material.

In an embodiment of the luminous garment of the present invention, the protective layer is formed by printing ultraviolet-curable ink onto the back electrode layer, followed by exposure to ultraviolet light for curing; the back electrode layer is formed by printing conductive silver paste onto the insulation layer, followed by drying; the insulating layer is formed by printing a mixture containing barium powder and a binding material onto the luminescent layer and subsequently dried; and the luminescent layer is formed by printing a mixture containing luminescent powder and a binding material onto the transparent conductive layer and subsequently dried.

In an embodiment of the luminous garment of the present invention, the transparent conductive layer is an ITO (Indium Tin Oxide) film.

In an embodiment of the luminous garment of the present invention, the pattern layer is a heat transfer paper, and the logo element is fixed onto the surface of the garment body by means of hot stamping.

The luminous garment according to the present invention provides functions of enabling a user to actively control the logo element to emit light or not and control the light emission mode thereof, which is different from the known way to make luminous clothes by attaching a light reflection strip to the clothes. The luminous garment according to the present invention is easier to use and has more functions.

### BRIEF DESCRIPTION OF THE DRAWINGS

FIG. 1A is a front view, in a schematic form, showing a luminous garment according to an embodiment of the present invention;

FIG. 1B is a rear view, in a schematic form, showing a luminous garment according to an embodiment of the present invention;

FIG. 1C is a sectional view showing a logo element of the luminous garment according to an embodiment of the present invention;

FIG. 2A is the block diagram showing a power source, a control module, an operation interface, and a logo element of the luminous garment according to the present invention;

FIG. 2B is a schematic view showing the connection among the power source, the control module, the operation interface, and the logo element of the luminous garment according to the present invention;

FIG. 3A is a schematic view showing the control module of the luminous garment according to the present invention arranged in an inside pocket of a garment body;

FIG. 3B is a schematic view showing the power source of the luminous garment according to the present invention arranged in an outside pocket of a garment body;

FIG. 4A is a schematic view showing the luminous garment is made in the form of a cap T-shirt; and

FIG. 4B is a schematic view showing the luminous garment is made in the form of a jacket.

### DETAILED DESCRIPTION OF THE PREFERRED EMBODIMENTS

A detailed description of the present invention, and technical contents thereof, will be explained below as a reference to the drawings. The drawings are provided only for illustration and reference to assist in understanding the present invention, and are not intended to limit the scope of the present invention.

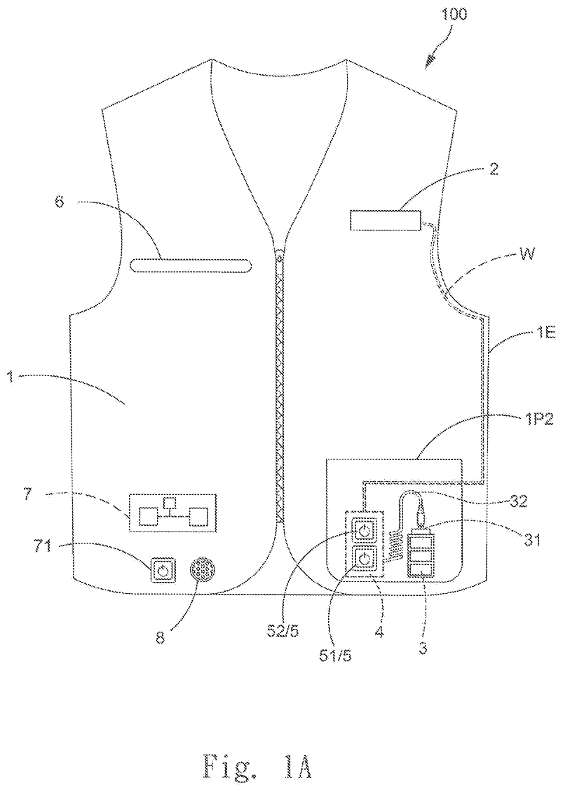

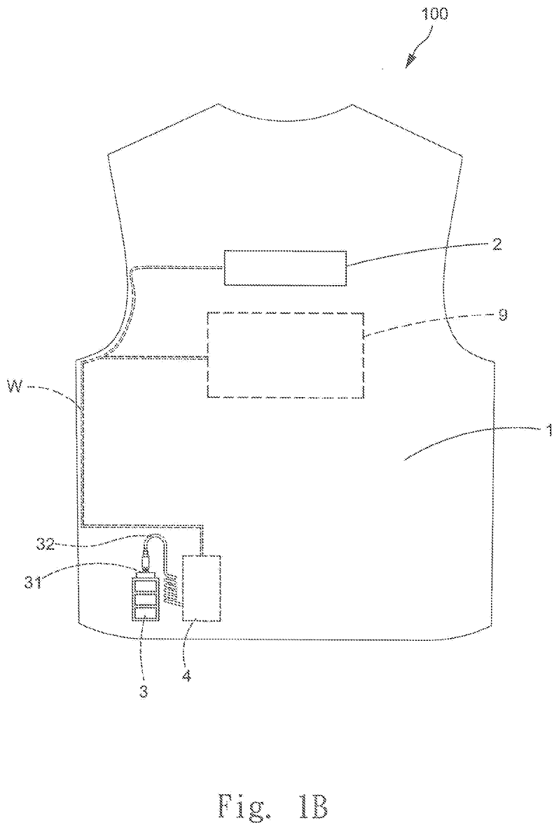

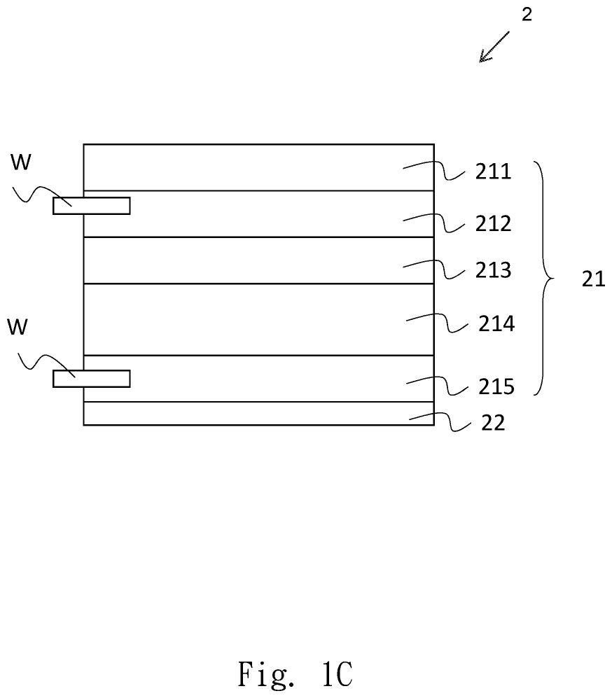

Firstly, referring to FIGS. 1A and 1B, schematic views of a luminous garment according to an embodiment of the present invention are provided. The luminous garment 100 comprises a garment body 1, a logo element 2, a power source 3, a control module 4, and an operation interface 5.

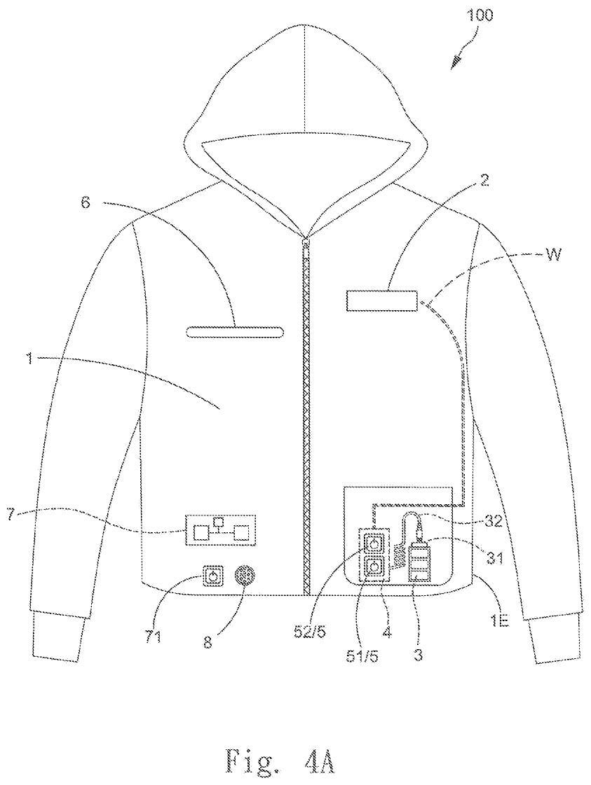

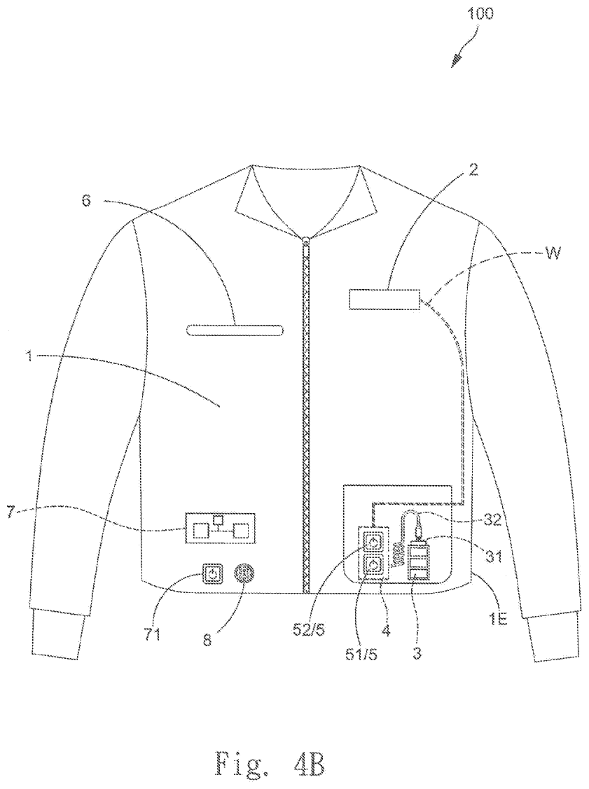

The garment body 1 is structured to cover the trunk of a human body and is formed with openings through which the head, the neck, and the hands may extend out, so as to be wearable on a user. The garment body 1 can be a workwear for technicians, or a casualwear for nighttime outdoor sports or leisure activities. The garment body 1 can be made in the form of a vest shown in FIGS. 1A and 1B, or a cap T-shirt shown in FIG. 4A, or a jacket shown in FIG. 4B, or clothing of other forms, such as coveralls. The garment body 1 can be wearable garments, accessories, footwear, safety wear, etc.

The logo element 2 is arranged on a surface of the garment body 1, for example being arranged at a location corresponding to the chest or the back of the human body, and the logo element 2 is exposed to the outside. The logo element 2 can be the marking showing a company logo, including characters, digits, patterns, or combinations of at least any two of the above. Once receiving an electrical current flowing therethrough, the logo elements 2 gives off light. The logo elements 2 works on the principle that the material emits light in an electric field or when an electric current passes therethrough. In an embodiment, light-emitting diodes (LEDs) are arranged to form the logo element; in an embodiment, luminescence sheets are arranged to form the logo element. When compared to LEDs, luminescence or electroluminescence sheets may save electrical power and give off relatively softer light. Also, the advantages of this configuration is that it is light, thin, durable and able to provide stable lighting.

As shown in FIG. 1C, the logo element 2 comprises a luminescence sheet 21 and a pattern layer 22. The luminescence sheet 21 comprises a protective layer 211, a back electrode layer 212, an insulating layer 213, a luminescent layer 214, and a transparent conductive layer 215. The transparent conductive layer 215 and the insulating layer 213 are respectively arranged on the upper and lower sides of the luminescent layer 214. The back electrode layer 212 is arranged between the insulating layer 213 and the protective layer 211. The other side of the protective layer 211 is fixed to the surface of the garment body 1, and the pattern layer 22 is arranged on the other side of the transparent conductive layer 215. In an embodiment, the luminescence sheet 21 is an electro luminescence material.

In an embodiment, the protective layer 211 is formed by printing ultraviolet-curable ink onto the back electrode layer 212, followed by exposure to ultraviolet light for curing. The protective layer 211 functions as insulation, sealing and protection.

The back electrode layer 212 is formed by printing conductive silver paste onto the insulation layer 213, followed by drying. The insulating layer 213 is formed by printing a mixture containing barium powder and a binding material onto the luminescent layer 214 and subsequently dried. The luminescent layer 214 is formed by printing a mixture containing luminescent powder and a binding material onto the transparent conductive layer 215 and subsequently dried. In an embodiment, the transparent conductive layer 215 is an ITO (Indium Tin Oxide) film.

In an embodiment, the pattern layer 22 is a heat transfer paper, and the logo element 2 is fixed onto the surface of the garment body 1 by means of hot stamping.

The power source 3 is arranged in garment body 1 and is connected (directly connected or indirectly connected through an intervening element therebetween) with the logo element 2 by means of an electrically conductive line W. In an embodiment, the two ends of the electrically conductive line W are respectively fixed on the transparent conductive layer 215 and the back electrode layer 212. The power source 3 can be a detachable battery or a non-detachable battery. The electrically conductive line W can be an electrical wire or a printed circuit. Optionally, a part of the electrically conductive line W extends along edge 1E of garment body 1 (such as a side or a hem) to connect to the logo element 2. The power source 3 may be electrically chargeable by means of an external device in a wired manner or wireless manner, or can be detached from the garment body 1 to be charged by other devices.

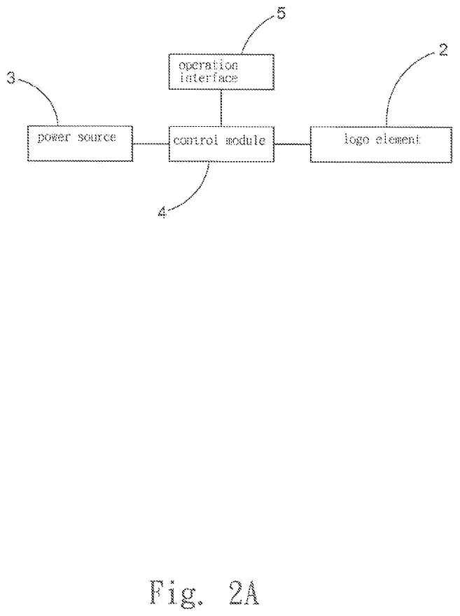

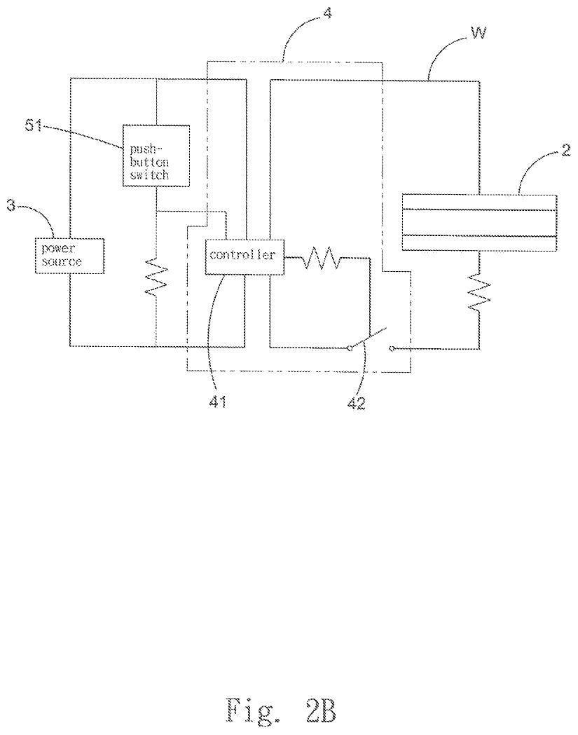

As shown in FIGS. 1A and 2A, the control module 4 is arranged on the garment body 1. The control module 4 is electrically connected to the power source 3 and the logo element 2. The operation interface 5 is arranged on garment body 1 and is electrically connected with the control module 4. The operation interface 5 is arranged for operation by the user to generate an operation signal (not shown), and to transmit the operation signal to the control module 4. The control module 4 is arranged to control, based on the operation signal, a light emission mode of the logo element 2. A wearer may operate the operation interface 5 to control the logo element 2 to emit light or not. During a nighttime operation, the logo element 2 that is formed as a company logo may emit light to assist in recognition of the employee identity of the wearer, in order to reduce the probability of being mistakenly thought as an unidentified person and also to reduce the risk of being attacked by the opposite party for alarming and defense purposes. The arrangement of the operation interface 5 and the power source 3 may be set on garment body 1 at locations corresponding to the waist or chest of the wearer.

As shown in FIG. 2B, the control module 4 may comprise a controller 41 and a power switch 42. The controller 41 may include components, such as a processor, a memory, a timer, and a signal input and output interface, and may be integrated with functions of analog to digital conversion, digital to analog conversion, voltage regulation, and voltage output. The controller 41 can be embodied as a chip or a circuit (such as a microcontroller unit (MCU), a microcomputer, and a single-board computer) that is programmable and can store and execute programs, store data, control hardware, and includes functions of timing and counting. The power switch 42 can be a transistor. The operation interface 5 can be a pushbutton switch 51. The pushbutton switch 51, when pressed down, is turned on to generate a voltage signal (which is the “operation signal” described above), and the controller 41, upon receiving the voltage signal generated by the pushbutton switch 51 that is so pressed down, issues a signal to control the power switch 42 to conduct on or shut down. The power switch 42, which is so controlled to conduct on or shut down, may control an electrical current to flow through the logo element 2 or not to thereby control the logo element 2 to give off light or not. Further, controller 41 can be programmed based on a relationship between the way the pushbutton switch 51 being pressed and the light emission mode of the logo element 2. For example, user can set the light emission of the logo element 2 to be various modes, such as “ON”, “OFF”, “FAST FLASHING”, “SLOW FLASHING” and “EXTENDED LIGHTING”. The control module 4 and the pushbutton switch 51 can be integrated into the same circuit board to ease mounting/dismounting and connecting in a modular fashion. Further, it is noted that various circuits and development kits are available for embodying the functions of the control module 4 and the operation interface 5 and they are not limited to what is shown in FIG. 2B. In addition, the operation interface 5 can alternatively be a rotary knob or switches of other types.

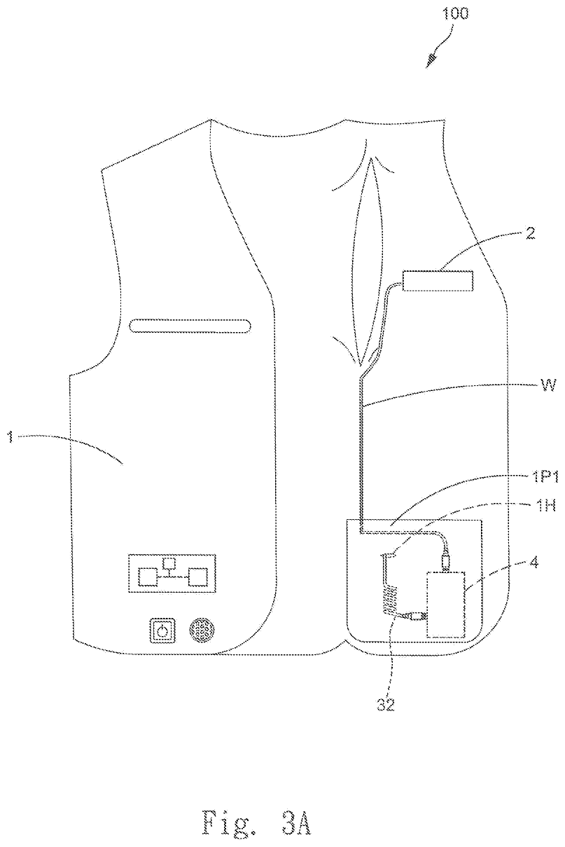

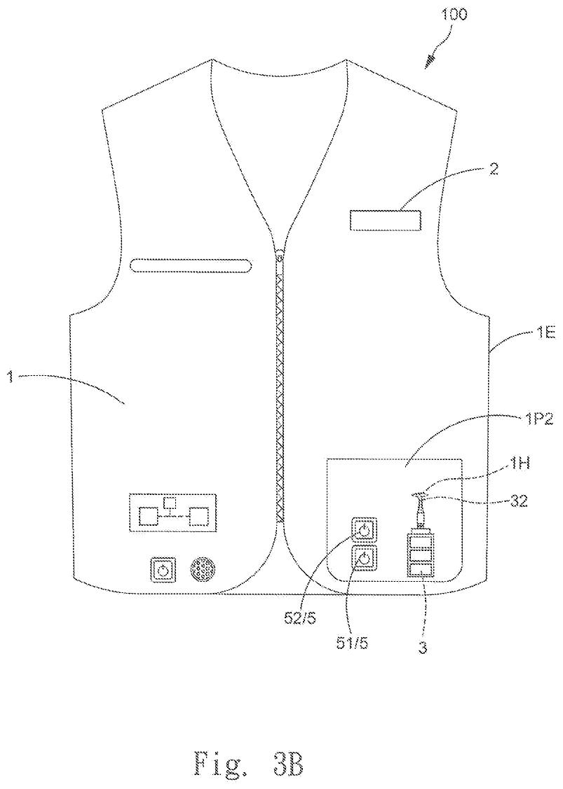

In an embodiment, the control module 4 is connected by a connection line 32 that is curled or wound in a helical form to a connection port 31 of the power source 3 to receive electrical power therefrom. The power source 3 is connected with the connection line 32 in a detachable manner (the connection line 32 has a connector that is in the form of the universal series bus (USB)). The helical connection line 32 is extendible with the movement of the power source 3 to allow the user to take out and remove the power source 3. Optionally, as shown in FIGS. 3A and 3B, the garment body 1 includes an inside pocket 1P1 and an outside pocket 1P2. The control module 4 is disposed in the inside pocket 1P1, while the power source 3 is arranged in the outside pocket 1P2. The connection line 32 extends through a hole 1H that is in communication with the inside pocket 1P1 and the outside pocket 1P2 to connect the control module 4 and the power source 3. Optionally, the connection structure between the control module 4 and the electrically conductive line W and the connection line 32 can be a detachable structure. As shown in FIG. 3A, each connector of the electrically conductive line W and the connection line 32 can be in USB form to ease detaching the control module 4 from the electrically conductive line W and the connection line 32.

Further, the luminous garment 100 comprises a LED light strip 6. The LED light strip 6 provides additional lighting for the wearer working in the nighttime. The LED light strip 6 is controllable by means of the pushbutton switch 52 and a corresponding control module (which may be combined with the previously discussed control module 4).

Further, the luminous garment 100 may comprise a communication module 7. The communication module 7 is arranged on garment body 1. The communication module 7 is arranged for operation by a user (the wearer) to transmit a distress signal to a remote device (not shown). The communication module 7 may include a wireless communication interface (such as a Wi-Fi chip, a global positioning system (GPS) chip, and an antenna), a controller, and an operation interface (which can be the pushbutton switch 71). The communication module 7 allows the luminous garment 100 and wearer to be positioned. The wearer may operate the pushbutton switch 71 to signal the controller, and the controller, in response to such signaling, controls the wireless communication interface to issue the distress signal. The remote device can be a mobile phone or a cloud platform. The communication module 7 may also be integrated with the previously described control module 4 and operation interface 5 on the same circuit board.

Further, the luminous garment 100 comprises a dog repellent device 8. The dog repellent device 8 is controllable by the wearer to give off an ultrasonic wave to repel a fierce dog to protect the safety of the wearer. The luminous garment 100 may also comprise a heating plate 9 (such as a graphene heating plate), which can be arranged on the garment body 1 at a location corresponding to the back of a human body in order to keep the wearer warm in the wintertime or cold days.

In summary of the above-described ways of embodiment, the luminous garment according to the present invention allows the wearer to actively control the logo element to emit light or not and the light emission mode thereof, and this is different from the known arrangement in which a reflective strip is employed to give off light. Further, the logo element of the luminous garment of the present invention can be arranged to present the logo of the company of the wearer for identity recognition. Thus, the luminous garment of the present invention is more convenient and versatile, and is suitable for technician who needs to work outdoors at night and people who do outdoor sports and leisure activities at nighttime.

The description provided above only illustrates the preferred embodiments of the present invention and is not intended to limit the scope of the present invention as defined in the claims. Equivalent alterations in respect of structures that are made according to the contents of the specification and the drawings of the present invention should be considered equally falling in the scope of the present invention defined by the claims.

What is claimed is:

1. A luminous garment, comprising:
a garment body for being put on a wearer;
a logo element arranged on the surface of the garment body to receive an electrical current to flow therethrough to emit light, the logo element comprising:
a luminescence sheet, the luminescence sheet comprising a protective layer, a back electrode layer, an insulating layer, a luminescent layer, and a transparent conductive layer, the transparent conductive layer and the insulating layer being respectively arranged on the upper and lower sides of the luminescent layer, the back electrode layer being arranged between the insulating layer and the protective layer, the other side of the protective layer being fixed to the surface of the garment body; and
a pattern layer being arranged on the other side of the transparent conductive layer;
a power source arranged on the garment body and connected by an electrically conductive line to the logo element;
a control module arranged on the garment body, the control module being electrically connected to the power source and the logo element; and
an operation interface arranged on the garment body and being electrically connected to the control module, the operation interface being arranged for operation by the wearer to generate an operation signal and to transmit the operation signal to the control module;
wherein the control module is arranged to control a light emission mode of the logo element according to the operation signal;
wherein the two ends of the electrically conductive line are respectively fixed on the transparent conductive layer and the back electrode layer.

2. The luminous garment according to claim 1, wherein the operation interface comprises a pushbutton switch.

3. The luminous garment according to claim 1, wherein the control module is connected to the power source by means of a connection line that is curled in a helical form, and the power source is detachably connected with the connection line.

4. The luminous garment according to claim 3, wherein the garment body includes an inside pocket and an outside pocket, the control module being arranged in the inside pocket, the power source being arranged in the outside pocket, the connection line extending through a hole that is in communication with the inside pocket and the outside pocket to connect to the control module and the power source.

5. The luminous garment according to claim 4, wherein the control module is detachably connected with the electrically conductive line and the connection line.

6. The luminous garment according to claim 1, wherein the logo element comprises marking that comprises digitals, characters, or patterns, or a combination of two of digital, character, and pattern.

7. The luminous garment according to claim 1, wherein the electrically conductive line comprises an electrical wire or a printed circuit.

8. The luminous garment according to claim 7, wherein a part of the electrically conductive line extends along an edge of the garment body to connect to the logo element.

9. The luminous garment according to claim 1, further comprising a LED light strip, the LED light strip being arranged on the garment body.

10. The luminous garment according to claim 1, further comprising a communication module, the communication module being arranged on the garment body, the communication module being arranged for operation by a user to transmit a distress signal to a remote device.

11. The luminous garment according to claim 1, further comprising a dog repellent device, the dog repellent device being arranged on the garment body.

12. The luminous garment according to claim 1, further comprising a heating plate, the heating plate is arranged on the garment body.

13. The luminous garment according to claim 1, wherein the luminescence sheet is an electro luminescence material.

14. The luminous garment according to claim 13, wherein the protective layer is formed by printing ultraviolet-curable ink onto the back electrode layer, followed by exposure to ultraviolet light for curing; the back electrode layer is formed by printing conductive silver paste onto the insulation layer, followed by drying; the insulating layer is formed by printing a mixture containing barium powder and a binding material onto the luminescent layer and subsequently dried; and the luminescent layer is formed by printing a mixture containing luminescent powder and a binding material onto the transparent conductive layer and subsequently dried.

15. The luminous garment according to claim 14, wherein the transparent conductive layer is an ITO (Indium Tin Oxide) film.

16. The luminous garment according to claim 1, wherein the pattern layer is a heat transfer paper, and the logo element is fixed onto the surface of the garment body by means of hot stamping.
